(19) United States
(12) Patent Application Publication
(10) Pub. No.: US 2023/0054936 A1
(43) Pub. Date: Feb. 23, 2023

(54) DATED OR UNDATED DIARY AND METHOD OF CONNECTING TO A DEDICATED WEB PAGE

(71) Applicant: BOOST S.P.A., San Paolo D'Argon (BG) (IT)

(72) Inventor: Cristiano PIZZAGALLI, Bergamo (BG) (IT)

(73) Assignee: BOOST S.P.A., San Paolo D'Argon (BG) (IT)

(21) Appl. No.: 17/759,193

(22) PCT Filed: Jan. 18, 2021
(86) PCT No.: PCT/IB2021/050352

§ 371 Date: Jul. 21, 2022

(30) Foreign Application Priority Data
Jan. 22, 2020 (IT) 102020000001156

(51) Int. Cl. B42D 3/12; G06K 19/077; G06K 7/10

(52) U.S. Cl. CPC B42D 3/12; G06K 19/077; G06K 7/10009; B42D 5/006

(57) ABSTRACT

A bound dated diary or a bound undated diary adapted to take notes is provided, which includes a passive RFID component, fixed directly or indirectly to the cover, which is configured to be interrogated by a NFC reading device, communicating to it a unique code that uniquely identifies the passive RFID component. A method of manufacturing a paper support with the passive RFID component hidden from view is also disclosed. The paper support can interact with a smartphone, or more generally with any device that can surf the net equipped with a NFC reading device, through a dedicated computer program that allows to implement a method of connecting to a web page uniquely associated with the paper support.

### TECHNICAL FIELD

The present invention relates in generating the items of stationery and more particularly to a bound dated diary or a bound undated diary incorporating a RFID passive component, and a method of connecting to a web page associated univocally to the diary.

### BACKGROUND

Undated paper diary and dated paper diary are still widely used for taking notes, despite the increasing use of mobile electronic devices. The latter are of practical use when short notes are to be taken, but the former are widely preferred for recording handwritten annotations or drawings due to their simplicity and immediacy of use. However, once an annotation has been written or a drawing has been made, a method is needed to record this information digitally so that it can be accessed when the paper is not available. For example, the hard copy may have been left in a specific physical place, for example the office, while the information contained in it may be needed in a different situation, for example in a meeting with a customer. Furthermore, it can happen that these paper supports are lost. Finally, the burden of having to physically store a large number of paper supports whose writing space is exhausted makes it even more preferable to have a digital archiving method that frees up physical storage space.

For this purpose the handwritten annotations or drawings contained in the paper supports must be captured digitally with a scanner or, more commonly, it is necessary to take a picture of the handwritten paper pages with a digital camera of a smartphone. However, these acquisition methods have the drawback of not favouring the storage of data in an organic way. Each image taken with a smartphone requires subsequent work by users in order to be properly archived, which makes saving paper supports through smartphone images a laborious task.

### SUMMARY

An objective of the present invention is to provide a bound undated diary or a bound dated diary configured to interact with a smartphone, for example to allow to store digitally information contained in it and, more generally, to activate some services that the manufacturer wishes to make available in a personalized way to customers.

This result is achieved with a bound dated diary or a bound undated diary adapted to take notes, which includes a cover and a plurality of pages bound together with said cover. It also includes a passive RFID component, fixed directly or indirectly to the cover, which is configured to be interrogated by an NFC reading device by communicating to it a unique code that uniquely identifies the RFID passive component and distinguishes it from any other RFID passive component nominally. identical to it. According to one aspect, the cover comprises an inner layer of cardboard covered with an outer liner and the passive RFID component is fixed to the inner layer of cardboard on a face of the inner layer facing the outside of the diary or of the undated diary when closed and is hidden from view by the outer lining.

The interaction with a smartphone, or more generally with any device that can surf the net equipped with an NFC reading device, takes place through a special computer program that allows to implement a method of connecting to a web page uniquely associated with the paper support.

### BRIEF DESCRIPTION OF THE DRAWINGS

FIG. 1 shows: a) a closed undated diary, according to the present disclosure; b) an open undated diary, according to the present disclosure.

FIG. 2 shows: a) a closed dated diary, according to the present disclosure; b) an open dated diary, according to the present disclosure.

FIG. 3 shows: a) a closed notebook, according to the present disclosure; b) an open notebook, according to the present disclosure.

FIG. 4 shows: a) a closed desk planner, according to the present disclosure; b) an open desk planner, according to the present disclosure.

FIG. 5 shows: a) a front view of a journal according to the present disclosure; b) a rear view of a journal according to the present disclosure.

### DETAILED DESCRIPTION

A bound paper support for taking annotations can be a product such as an undated diary, a notebook, a journal, a calendar, a desk planner or even a dated diary. All these products, exemplified in the attached figures, generally have a cover with an internal layer of cardboard and a plurality of pages bound together with the cover, as well as similar products currently on the market. Unlike the products commonly available on the market, the products shown in the figures comprise a passive RFID component 1 fixed directly to the inner cardboard layer of the cover 2 on one of its faces facing the outside of the dated or undated diary when closed. Moreover, the RFID passive component 1 is hidden from view by an outer lining that covers the inner cardboard layer.

The passive RFID component 1, installed in the paper support of this disclosure, is configured to be interrogated by an NFC reading device and is also configured so that, when interrogated by the NFC reading device, it communicates to it a corresponding unique code that identifies univocally the passive RFID component 1 and distinguishes it from any other passive RFID component nominally identical to it.

In other words, dated diary or undated diary will have respective passive RFID components 1 even identical to each other, but configured to communicate different codes so that, by approaching an NFC reading device to the passive RFID component 1, a diary is exactly identified without any possibility of confusion with other paper supports of the same type.

It should be noted that the passive RFID component 1 differs from the normal anti-theft RFID elements, commonly installed on the products for sale. The latter are in fact applied on the products in such a way as to transmit only an active signal, which is the same for all products, to recognize the products that have not yet been paid. In addition, the anti-theft RFID elements are deactivated at the time of payment and remain deactivated, while the passive RFID component 1 remains interrogable for the entire useful life of the product.

According to one aspect, the passive RFID component 1 contains an electronic microchip and the unique code transmitted will be the identification code of the electronic microchip.

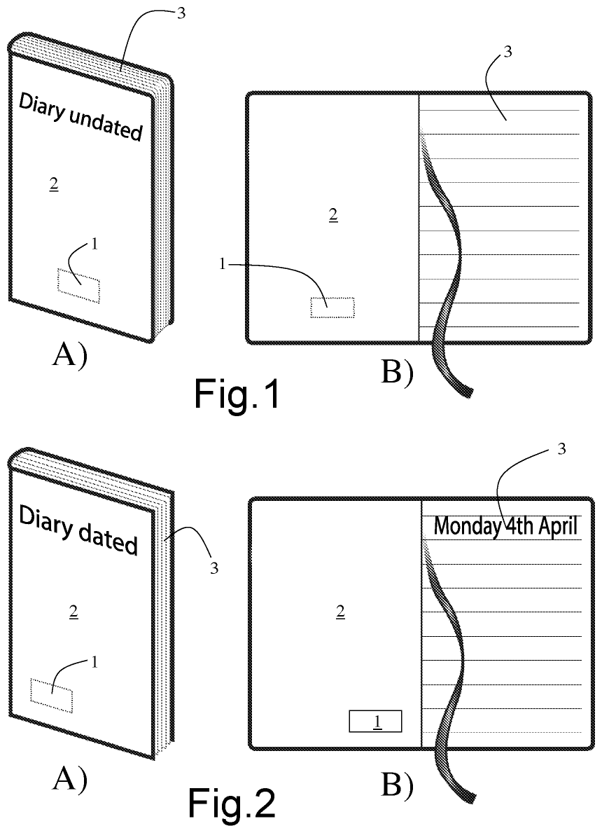

According to an aspect illustrated in FIGS. 1, 3 and 4, the passive RFID component 1 is incorporated in the body of the cover and is hidden from view by an outer lining of the cover 2. This is preferable so that the paper support of the present disclosure appears from the outside exactly like any other paper support, avoiding that the passive RFID component alters its appearance. Conveniently, the passive RFID component 1 is fixed on the inner layer of cardboard on a face facing outwards when the diary is closed, so as to be read easily without having to open the dated diary or the undated diary.

Such a paper support may be manufactured through the following operations:
making a cover 2 of the paper support by covering the cardboard layer with the external lining, so as to cover the passive RFID component 1 hiding it from view;
finally, binding a plurality of pages 3 together with the cover.

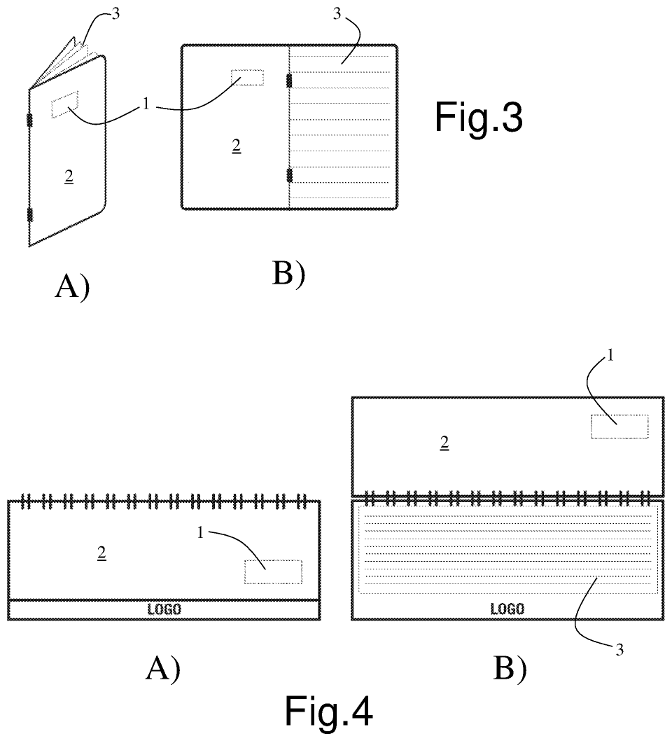

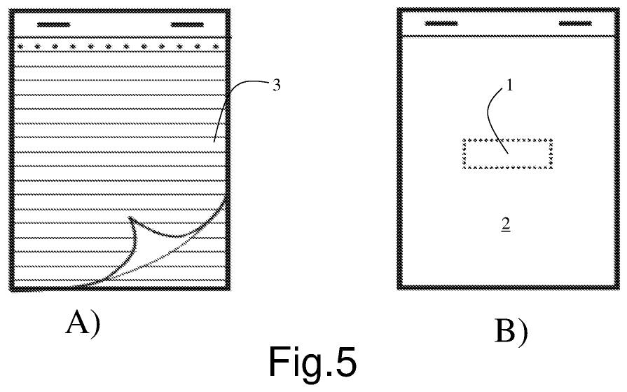

As shown in FIGS. 3 and 4, the passive RFID component may also be installed in the same way on notebooks (FIG. 3) or on desk planners (FIG. 4). Although it is not shown in the drawings, it can easily be installed on the covers of wall or table calendars as well as on the cover 2 of a journal (FIG. 5). In the latter case, it is possible to advantageously exploit the cardboard cover, which is located on the bottom of the journal and which acts as a rigid support to bear the sheets 3 of the notebook.

The paper support of this disclosure is therefore designed to interact, through a computer program, with any device, such as a smartphone, which can surf the net and is equipped with an NFC reading device. The program according to the present disclosure can be downloaded on a smartphone equipped with an NFC reading device and a browser application, and will include a software code configured so that, when in execution:
the NFC reading device smartphone interrogate the passive RFID component 1 placed in proximity of the NFC reading device, communicating to it the corresponding unique code that uniquely identifies it;
activates the browser application of the smartphone, opening a web page uniquely defined by the unique code.

Once the program has been installed on a smartphone, it is sufficient to bring the smartphone close to the paper support to receive the unique code transmitted by the passive RFID component 1, and the browser application of the smartphone will be activated opening a web page uniquely defined by the unique code and therefore uniquely assigned to paper support. On this dedicated web page, the producer of the paper support will be able to offer a plurality of services available to the buyer, including for example after-sales information regarding the paper support.

According to one aspect, on the dedicated web page it will be possible to activate a dedicated cloud storage space accessible only through this web page. For example, the first connection to the web page will activate a cloud storage space having a nominal storage capacity sufficient to store a number of image files corresponding to a number of pages of the dated or undated diary, and at each connection to this web page after the first connection the dedicated storage space and the files it contains will be accessed, with the possibility of storing new files until the nominal storage capacity is exhausted. Preferably, such a dedicated storage space will be provided by the manufacturer free of charge to customers. In practice, when a page is completely filled with notes, the user can open the dedicated web page by bringing his smartphone close to the paper support, he will take a picture of the completed page, and can save the image file of the picture in the storage space which is preferably made available free of charge. In this way, even if the paper support was lost or simply forgotten, the user would always have the possibility to read his notes by recovering the saved image files simply by connecting to the dedicated web page, which he will have previously stored.

Conveniently, access to the dedicated storage space can be protected with an ID and a password, created by the user at the first access to the dedicated web page.

1. A bound, paper support, comprising:
a hard cover comprising an inner layer of cardboard covered with an outer lining;
a plurality of pages bound together with said hard cover;
a passive Radio Frequency Identification (RFID) component, fixed directly on said inner layer of cardboard of said hard cover, said passive RFID component being fixed on a face of the inner layer of cardboard, said passive RFID component being hidden from view by said outer lining, wherein said passive RFID component is configured to transmit a unique code which uniquely identifies said passive RFID component.

2. The bound paper support of claim 1, wherein said passive RFID component comprises a microchip and said unique code is an identification code of said microchip.

3. A method comprising:
interrogating, by a smartphone comprising a Near Field Communication (NFC) reading device, a passive Radio Frequency Identification (RFID) component disposed in a bound paper support;
receiving, by the smartphone, from said passive RFID component, a code which uniquely identifies said passive RFID component;
generating, by the smartphone, a plurality of images associated with respective pages of the bound paper support;
accessing, by the smartphone, a web page based on said code; and
causing, by the smartphone, the web page to store in a cloud storage space the plurality of image files associated with the bound paper support.

4. The bound paper support of claim 1, wherein said passive RFID component is further configured to transmit the unique code when the RFID component is interrogated by a Near Field Communication (NFC) reading device.

5. The bound paper support of claim 1, wherein aid passive RFID component faces an outside of the paper support when the paper support is closed.
